(19) United States
(12) Patent Application Publication
(10) Pub. No.: US 2016/0341854 A1
(43) Pub. Date: Nov. 24, 2016

(54) METHODS FOR MAKING REFLECTIVE TRAYS

(71) Applicant: 3M INNOVATIVE PROPERTIES COMPANY, Saint Paul, MN (US)

(72) Inventors: Samuel KIDANE, Cupertino, CA (US); James W. LAUMER, White Bear Lake, MN (US); Karl K. STENSVAD, Inver Grove Heights, MN (US)

(21) Appl. No.: 15/108,015

(22) PCT Filed: Dec. 18, 2014
(86) PCT No.: PCT/US2014/071232

§ 371 Date: Jun. 24, 2016

Related U.S. Application Data
(60) Provisional application No. 61/920,883, filed on Dec. 26, 2013.

(51) Int. Cl. G02B 5/08; F21V 8/00

(52) U.S. Cl. CPC G02B 5/0841; G02B 6/0033

(57) ABSTRACT

A method of making a reflective tray that is useful in backlight modules for electronic devices comprises (a) providing a reflective tray template comprising a polymeric dielectric multilayer reflector on a compliant pad, the reflective tray template having a first major surface, an opposing major surface, and a reflective tray bottom area having corners; and (b) pressing a blade into the first major surface of the polymeric dielectric multilayer reflector along the perimeter of at least one side of the reflective tray bottom area to form a reflective tray side extending perpendicular to the reflective tray bottom area.

### FIELD

This invention relates to methods for making reflective trays that are useful in backlight modules for electronic devices.

### BACKGROUND

Electronic devices, in particular hand-held electronic devices having a liquid crystal display (LCD), utilize backlights having optimized arrangements of light management films, reflectors and light guides to efficiently distribute the light generated by advanced light sources such as light emitting diodes (LEDs). It can be desirable to ensure that light from the backlight is not leaked to areas that are not intended to be illuminated, while still maintaining a compact size and a narrow bezel.

### SUMMARY

We have discovered that reflective trays can be used in backlight modules to reduce the tendency of light to leak into unwanted areas. Backlight modules incorporating reflective trays form a compact unit having a narrow bezel that at least partially surrounds the components of the backlight and/or the display.

In one aspect, the present disclosure provides a method of making reflective trays that can be used in backlight modules. The method comprises (a) providing a reflective tray template comprising a polymeric dielectric multilayer reflector on a compliant pad, the reflective tray template having a first major surface, an opposing major surface, and a reflective tray bottom area having corners; and (b) pressing a blade into the first major surface of the polymeric dielectric multilayer reflector along the perimeter of at least one side of the reflective tray bottom area to form a reflective tray side extending perpendicular to the reflective tray bottom area.

### BRIEF DESCRIPTION OF THE DRAWINGS

Throughout the specification reference is made to the appended drawings, where like reference numerals designate like elements, and wherein:

FIG. 1A shows a perspective schematic view of a reflective tray template;

FIG. 1B shows a perspective schematic view of a reflective tray formed from the template of FIG. 1A;

FIG. 2A shows a perspective schematic view of a backlight article;

FIG. 2B shows an exploded cross-sectional schematic view of a backlight module;

FIG. 2C-2H show a cross-sectional schematic view of a backlight module;

FIG. 3 shows a perspective schematic view of a backlight module;

FIG. 4A shows a perspective schematic view of a reflective tray template; and

FIG. 4B shows a perspective schematic view of a reflective tray formed from the template of FIG. 4A.

FIG. 5 shows a cross-sectional schematic view of a setup for bending a reflective film.

FIG. 6 shows an image of the film bent using the setup of FIG. 5.

FIG. 7A shows a cross-sectional schematic view of film with two 45° bends being bended.

FIG. 7B shows a cross-sectional schematic view of the film with two 45° bends from FIG. 7A.

FIG. 8 shows a cross-sectional schematic view of a bended film made by simultaneously bending two edges with two flat-tipped blades.

FIG. 9 shows a cross-sectional schematic view of a setup for bending a reflective film.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The present disclosure relates to methods of making reflective trays useful for backlight modules. Backlight modules incorporating reflective trays have a reduced tendency to leak light into unwanted areas. They also form a compact unit having a narrow bezel that at least partially surrounds the components of the backlight and/or the display.

In one particular embodiment, a template can be cut from a reflector and bended to form a reflective tray that encloses a light source, a light guide and one or more light management films. The reflective tray has an open top surface that is placed adjacent an LCD panel and either partially surrounds the LCD or is adhered to a surface of the LCD such that light passes through the LCD and is prevented from leaking from around the light source, light guide or light management films.

The reflector can be any suitable reflector including, for example, diffuse reflectors, specular reflectors, semi-specular reflectors and the like. The reflector can be made from a variety of materials including, for example, metals or metal alloys, metal or metal alloy coated polymers, organic or inorganic dielectric multilayer reflectors or a combination thereof. In one particular embodiment, the reflector is preferably a polymeric dielectric multilayer reflector such as ESR (enhanced specular reflector) available from 3M Company. In some embodiments, the polymeric dielectric multilayer reflector contains a black coating such as ESR-B2 available from 3M Company. In some embodiments, the polymeric dielectric multilayer reflector comprises a liner. The light management films typically comprise one or more reflective polarizer films, diffuser films, microstructured brightness enhancing films or a combination thereof, as known to one of skill in the art.

In the following description, reference is made to the accompanying drawings that forms a part hereof and in which are shown by way of illustration. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure. Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise. Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “connected to,” “coupled with” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

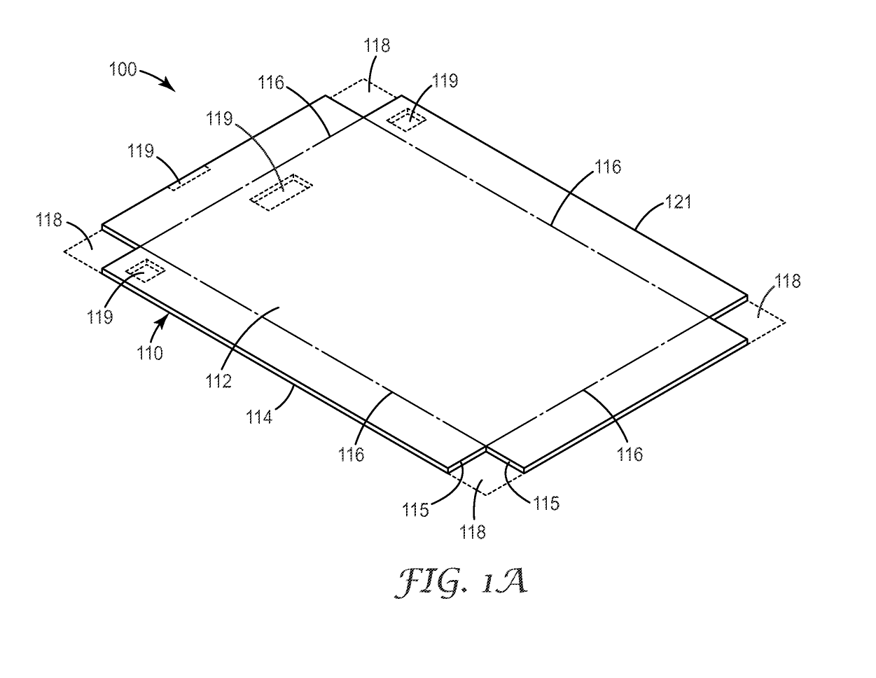

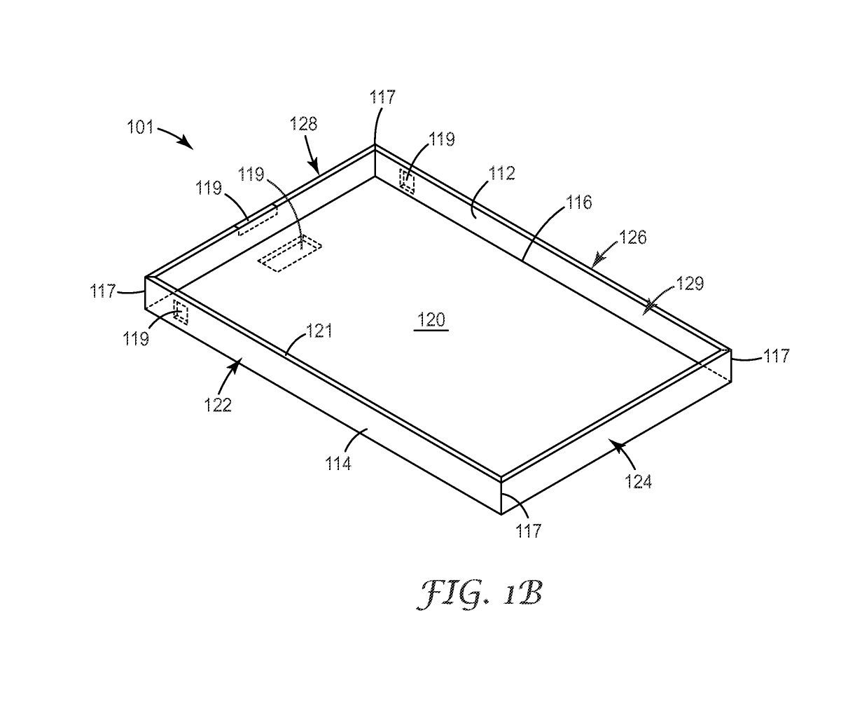

FIG. 1A shows a perspective schematic view of a reflective tray template 100 that can be used to form a reflective tray according to methods of the disclosure. Reflective tray template 100 is made from a reflective sheet 110 that includes a first major surface 112, an opposing second major surface 114, a reflective tray bottom area 120 and a perimeter 121. Exterior portions 118 are removed from the corners of the reflective sheet 110 to form edges 115, and optional openings 119 are cut through the thickness dimension of the reflective sheet. The exterior portions 118 and optional openings 119 can be removed using any suitable technique including, for example, knife cutting, die cutting, punching, laser cutting, and the like. Bending line 116 that is generally parallel to and separated from the perimeter 121 defines reflective tray bottom area 120. Bending line 116 denotes where reflective sheet 110 can be bended to form a reflective tray having sides and a bottom, as described elsewhere. Bending line 116 can be visibly marked on reflective sheet 110 but it is not necessary.

FIG. 1B shows a perspective schematic view of a reflective tray 101 formed from the bendable template 100 of FIG. 1A. Reflective tray 101 is formed by bending up each of the portions between the bending line 116 and perimeter 121 so that each of the edges 115 meet to form a corner 117. Reflective tray 101 includes a bottom area 120, a first through fourth sides 122, 124, 126, and 128, an open top 129, and interior surface 112 and exterior surface 114. Optional openings 119 are positioned in any or all of the bottom area 120 and sides 122, 124, 126, 128 as desired, for external attachment of components within the reflective tray 101, for through-passage of electrical lines from the exterior to the interior of the tray, for passage of light from an exterior light source to the interior of the tray, and the like, as described elsewhere.

In one particular embodiment, corners 117 may include an adhesive layer (not shown) or an adhesive tape (not shown) to bond the respective sides together. In some cases, corners 117 may be bonded together by other techniques including thermal bolding, ultrasonic welding, laser welding, or mechanical methods including slot/tab techniques and the like, as known to one of skill in the art.

A variety of layers can be applied to any desired portion of the interior surface 112 and/or the exterior surface 114, as desired. These layers are optional, and can include coatings, films, and sheets that are deposited, adhered, laminated, or otherwise affixed to the respective surface. In one particular embodiment, the layer applied to the exterior surface 114 can be, for example, a thermally conductive layer, an optically absorptive layer, a structural supporting layer, a combination thereof, and the like. In some cases, a thermally conductive exterior layer having, for example, thermally conductive particles in a binder, or metallic films or sheets, can be useful for aiding extraction of heat from a light source (not shown) that is placed within the reflective tray 101, as described elsewhere. In one particular embodiment, the layer applied to the interior surface 112 can be a diffuse layer, an optically absorptive layer, or a combination thereof. In some cases, a diffuse layer can be preferably applied to the interior surface 112 of one or more of the sides 122, 124, 126, 128, or the bottom 120, of the reflective tray 101.

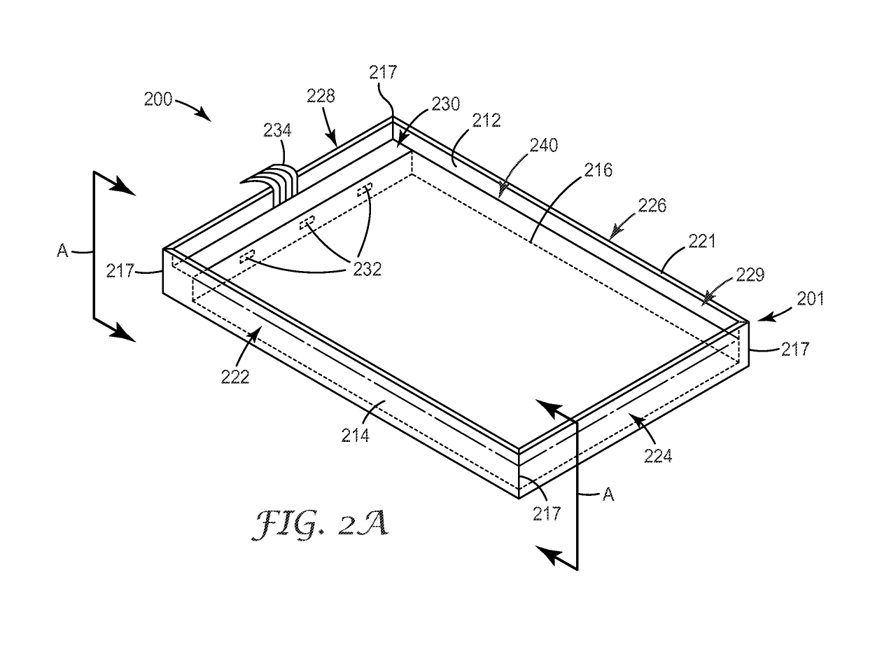

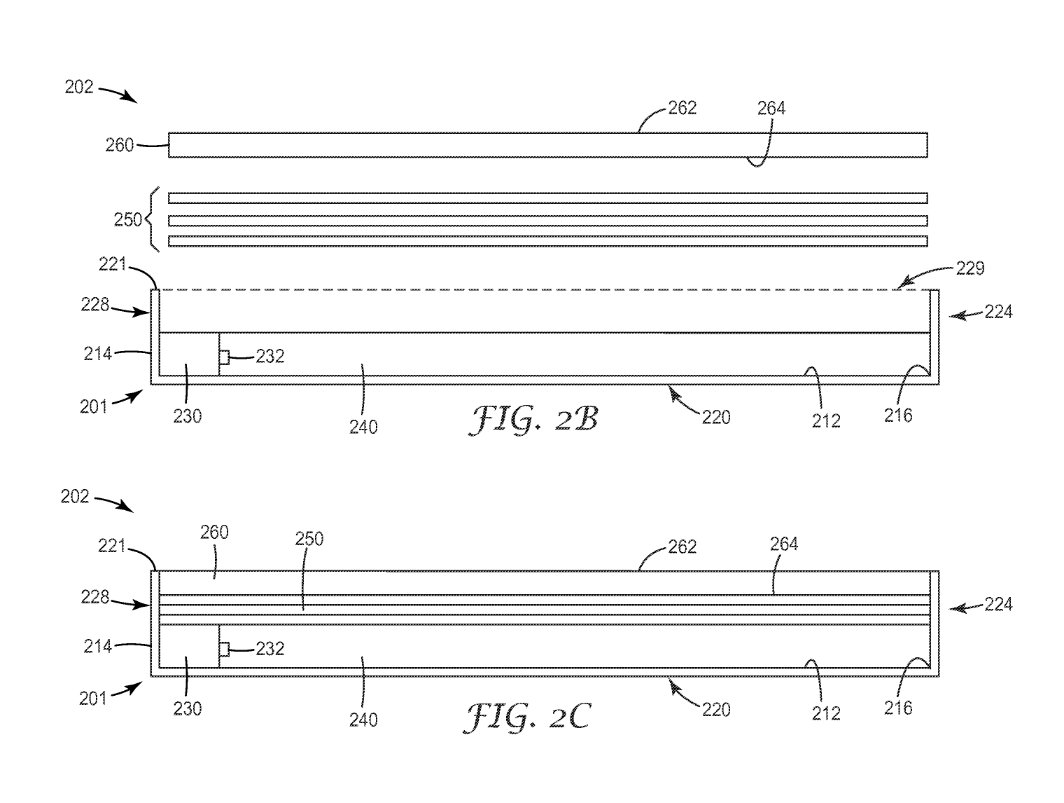

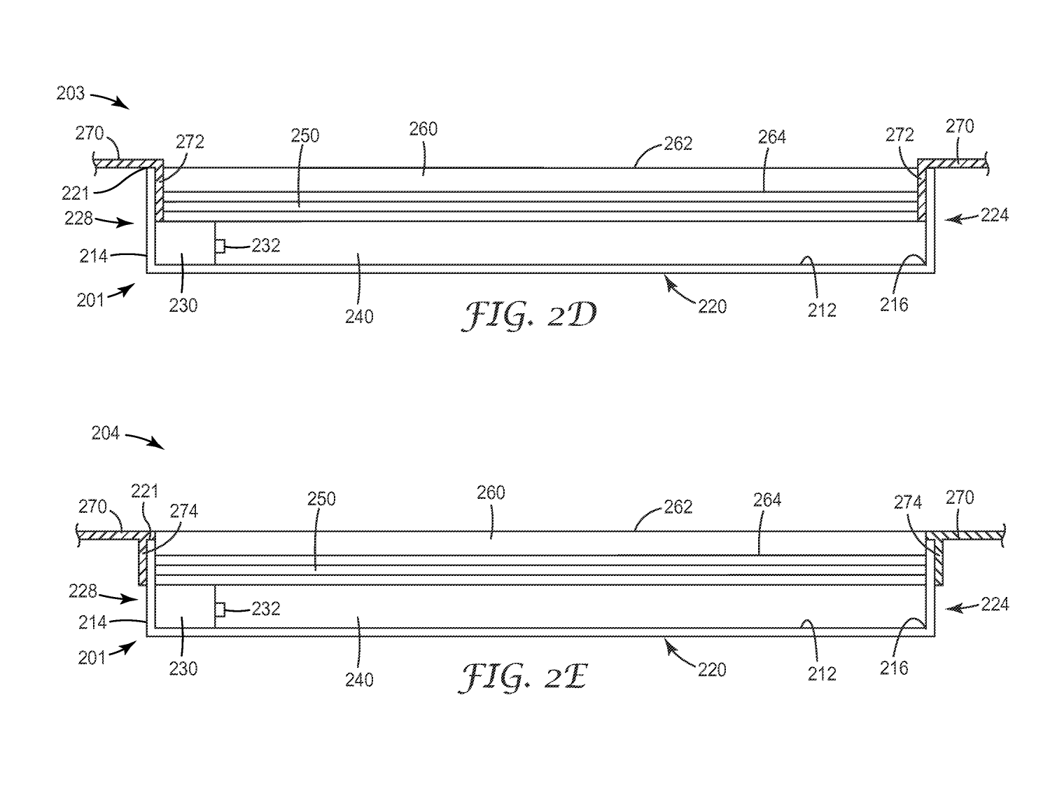

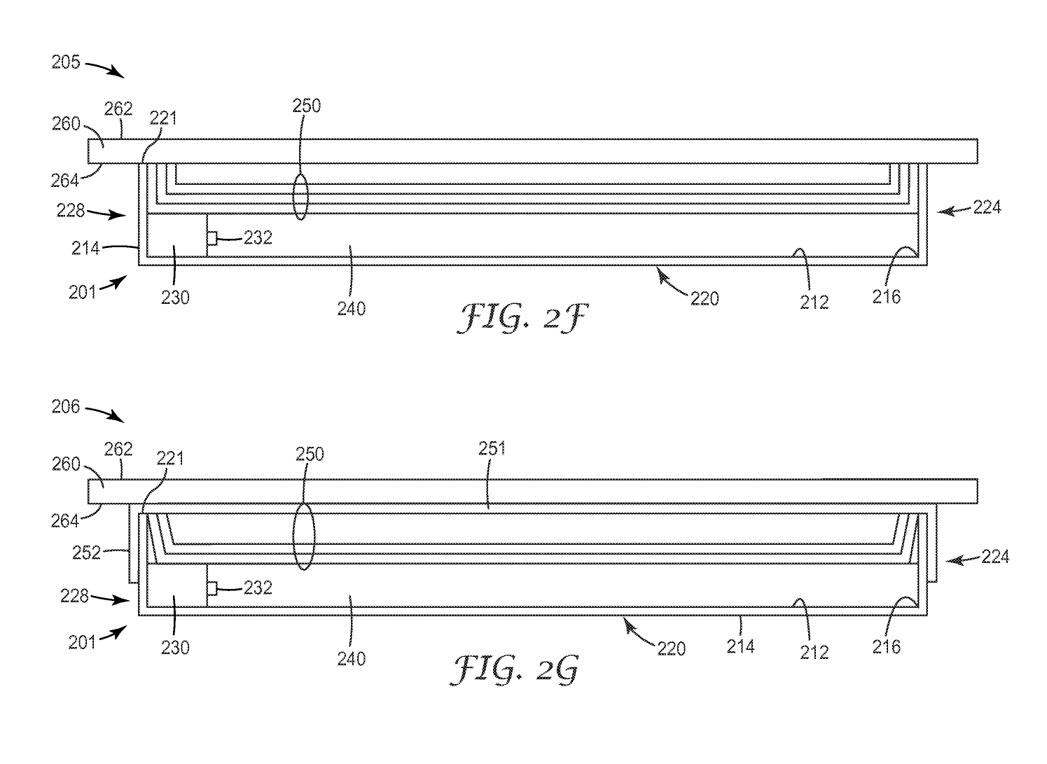

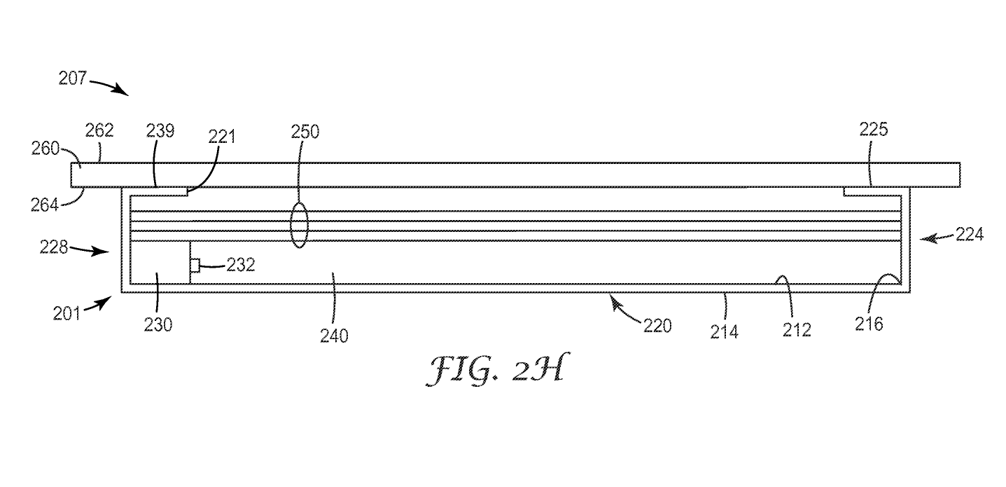

FIG. 2A shows a perspective schematic view of a backlight article 200. Each of the elements 201-229 shown in FIG. 2A correspond to like-numbered elements 101-129 shown in FIG. 1B, which have been described previously. For example, corner 217 in FIG. 2A corresponds to corner 117 in FIG. 1B, and so on. Backlight article 200 includes a reflective tray 201 having sides 222, 224, 226, 228, bottom area 220, interior surface 212, exterior surface 214, bending line 216, and perimeter 221. Reflective tray 201 houses a light source 230 disposed adjacent side 228, one or more lights 232 (e.g., LEDs or other light sources as known in the art), and an electrical connection 234 that extends to the exterior of reflective tray 201. The electrical connection 234 either passes through optional openings (not shown, described elsewhere) or over the perimeter 221. A light guide 240, such as a light guide plate is optically coupled to the light source 230 and placed within reflective tray 201 of the backlight article 200, and bounded by the sides 222, 224, 226, 228. Light guide 240 and light source 230 may include portions that pass through optional openings (not shown, described elsewhere) for other connections or structural support. In some cases, portions of light source 230 may be located externally to the reflective tray 201, and light can pass through the optional openings.

FIG. 2B shows an exploded cross-sectional schematic view of backlight module 202 through section A-A′ of backlight article 200 of FIG. 2A, according to one aspect of the disclosure. Each of the elements 201-240 shown in FIG. 2B correspond to like-numbered elements 201-240 shown in FIG. 2A, which have been described previously. Backlight module 202 includes a reflective tray 201 having sides 224, 228, bottom 220, interior surface 212, exterior surface 214, bending line 216, a light source 230 having at least one light 232, and light guide 240 optically coupled to light source 230. A light management film stack 250 having at least one light management film is disposed to be place within reflective tray 201, through top opening 229. An LCD panel 260 having a top surface 262 and an opposing bottom surface 264, is positioned adjacent the light management film stack 250.

FIG. 2C shows a cross-sectional schematic view of a backlight module 202 including an LCD panel 260, according to one aspect of the disclosure. Each of the elements 201-264 shown in FIG. 2C correspond to like-numbered elements 201-264 shown in FIG. 2B, which have been described previously. Backlight module 202 includes a reflective tray 201 having sides 224, 228, bottom area 220, interior surface 212, exterior surface 214, bending line 216, a light source 230 having at least one light 232, and light guide 240 optically coupled to light source 230. A light management film stack 250 having at least one light management film is disposed within reflective tray 201, and an LCD panel 260 having a top surface 262 and an opposing bottom surface 264 is positioned adjacent the light management film stack 250.

In one particular embodiment, the LCD panel 260 can fit within reflective tray 201, as shown in FIG. 2C, and each of the sides 224, 228, can be affixed to one or more of the LCD panel 260, the light management film stack 250, the light source 230, and the light guide 240, by an adhesive layer (not shown). In some cases, the top surface 262 of the LCD panel 260 can be at the same level with the perimeter 221 of reflective tray 201, as shown in FIG. 2C. In some cases, the top surface 262 of the LCD panel 260 can be positioned either above or below the perimeter 221 of reflective tray 201.

In one particular embodiment, the LCD panel 260 can be larger than the reflective tray 201, and the perimeter 221 of reflective tray 201 can be positioned adjacent bottom surface 264 of LCD panel 260 (not shown), as described elsewhere. In some cases, an adhesive layer (also not shown) can attach the perimeter 221 of the reflective tray 201 to the bottom surface 264 of LCD panel 260.

FIG. 2D shows a cross-sectional schematic view of a backlight module 203 including an LCD panel 260, according to one aspect of the disclosure. Each of the elements 201-264 shown in FIG. 2D correspond to like-numbered elements 201-264 shown in FIG. 2C, which have been described previously. Backlight module 203 includes a reflective tray 201 having sides 224, 228, bottom area 220, interior surface 212, exterior surface 214, bending line 216, a light source 230 having at least one light 232, and light guide 240 optically coupled to light source 230. A light management film stack 250 having at least one light management film is disposed within reflective tray 201, and an LCD panel 260 having a top surface 262 and an opposing bottom surface 264 is positioned adjacent the light management film stack 250. A frame 270 having a flange 272 is positioned around the LCD panel 260, adjacent the interior surface 212 of the sides 224, 228. It is to be understood that the flange 272 also can also extend adjacent the interior surface 212 of the sides 222, 226 shown in FIG. 2A. The flange 272 provides for support of the components in the backlight module 203, and each of the components can be affixed to the flange 272 by, for example, adhesives or mechanical means. In some cases, the flange 272 can extend for any distance from the perimeter 221 toward the bottom 220, and can even extend to contact the bottom 220. The other components (i.e., light source 230, light guide 240, light management film stack 250 and LCD panel 260) within reflective tray 201 are sized accordingly to accommodate the flange 272.

FIG. 2E shows a cross-sectional schematic view of a backlight module 204 including an LCD panel 260, according to one aspect of the disclosure. Each of the elements 201-264 shown in FIG. 2E correspond to like-numbered elements 201-264 shown in FIG. 2D, which have been described previously. Backlight module 204 includes a reflective tray 201 having sides 224, 228, bottom area 220, interior surface 212, exterior surface 214, bending line 216, a light source 230 having at least one light 232, and light guide 240 optically coupled to light source 230. A light management film stack 250 having at least one light management film is disposed within reflective tray 201, and an LCD panel 260 having a top surface 262 and an opposing bottom surface 264 is positioned adjacent the light management film stack 250. A frame 270 having a flange 274 is positioned around the reflective tray 201, adjacent the exterior surface 214 of the sides 224, 228. It is to be understood that the flange 274 also can also extend adjacent the exterior surface 214 of the sides 222, 226 shown in FIG. 2A. The flange 274 provides for support of the components in the backlight module 203, and the exterior surface 214 can be affixed to the flange 274 by, for example, adhesives or mechanical means. In some cases, the flange 274 can extend for any distance from the perimeter 221 toward the bottom 220, and can even extend beyond the bottom 220.

In one particular embodiment, the positions of flange 272 in backlight module 203 shown in FIG. 2D and flange 274 in backlight module 204 shown in FIG. 2E, can be combined such that at least one of the sides 222, 224, 226, 228 can be partially encased (not shown) within the respective flange; i.e., both the interior surface 212 and exterior surface 214 of the partially encased side is in contact with the flange.

FIG. 2F shows a cross-sectional schematic view of a backlight module 205 including an LCD panel 260, according to one aspect of the disclosure. Each of the elements 201-264 shown in FIG. 2F correspond to like-numbered elements 201-264 shown in FIG. 2C, which have been described previously. Backlight module 205 includes a reflective tray 201 having sides 224, 228, bottom area 220, interior surface 212, exterior surface 214, bending line 216, a light source 230 having at least one light 232, and light guide 240 optically coupled to light source 230. A light management film stack 250 having at least one light management film is bended in a manner similar to the template shown in FIG. 1A, and disposed within reflective tray 201, and an LCD panel 260 having a top surface 262 and an opposing bottom surface 264 is positioned adjacent the light management film stack 250. The LCD panel 260 can be larger than the reflective tray 201, and the perimeter 221 of reflective tray 201 can be positioned adjacent bottom surface 264 of LCD panel 260. In some cases, an adhesive layer (not shown) can attach the perimeter 221 of the reflective tray 201 to the bottom surface 264 of LCD panel 260.

FIG. 2G shows a cross-sectional schematic view of a backlight module 206 including an LCD panel 260, according to one aspect of the disclosure. Each of the elements 201-264 shown in FIG. 2G correspond to like-numbered elements 201-264 shown in FIG. 2C, which have been described previously. Backlight module 205 includes a reflective tray 201 having sides 224, 228, bottom area 220, interior surface 212, exterior surface 214, bending line 216, a light source 230 having at least one light 232, and light guide 240 optically coupled to light source 230. A first portion of light management film stack 250 having at least one light management film is bended in a manner similar to the template shown in FIG. 1A, and disposed within reflective tray 201.

A second portion of the light management film stack 250 (e.g., a topmost film 251, bended in a manner similar to the template shown in FIG. 1A) extends across the top opening 229 and can extend as flaps 252 disposed adjacent the exterior surface 214 of sides 224, 228 (and also sides 222, 226 not shown in this view, as described elsewhere). In some cases, the second portion of the light management film stack 250 (e.g., topmost film 251, bended in a manner similar to the template shown in FIG. 1A) can extend across the top opening 229 and can extend as flaps 252 disposed adjacent the interior surface 212 (not shown) of sides 224, 228 (and also sides 222, 226 not shown in this view, as described elsewhere). The flaps 252 can be adhered to the exterior surface 214 (or alternately the interior surface 212) using, for example, an adhesive, thereby forming a sealed reflective tray 201. In some cases, a combination of attachment of one or more of the sides 222, 224, 226, 228, to either the interior surface 212 or the exterior surface 214 can be used. An LCD panel 260 having a top surface 262 and an opposing bottom surface 264 can be positioned adjacent the topmost film 251 of the light management film stack 250.

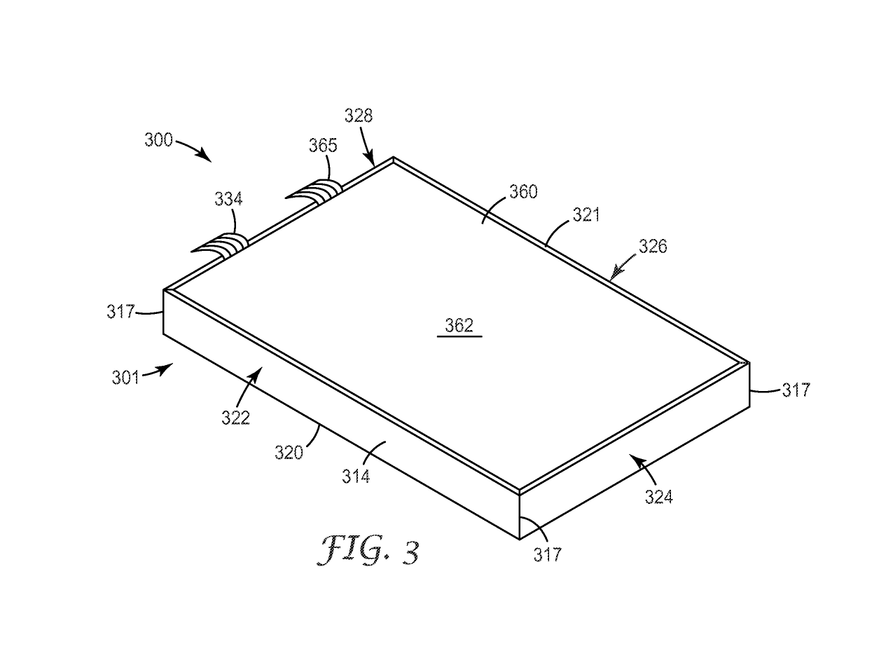

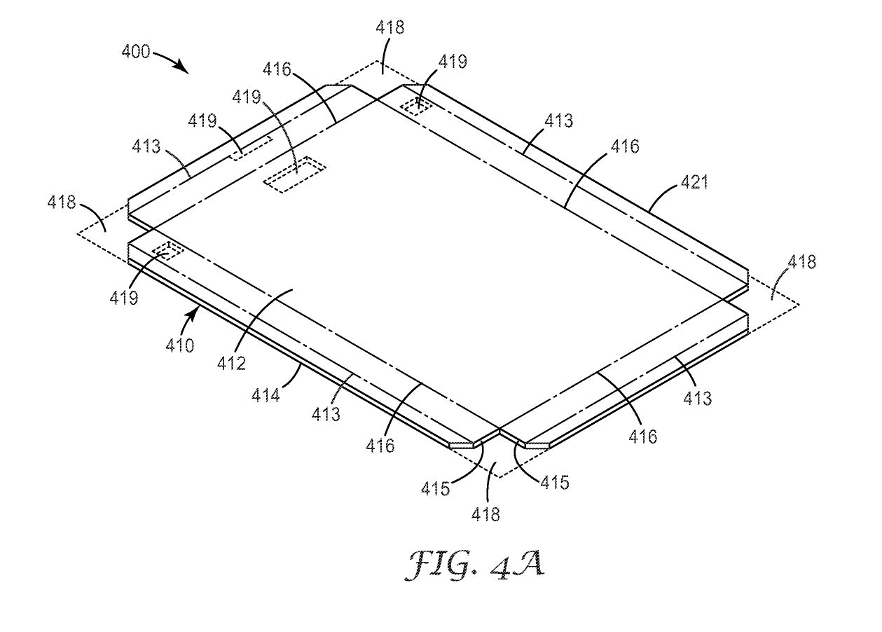

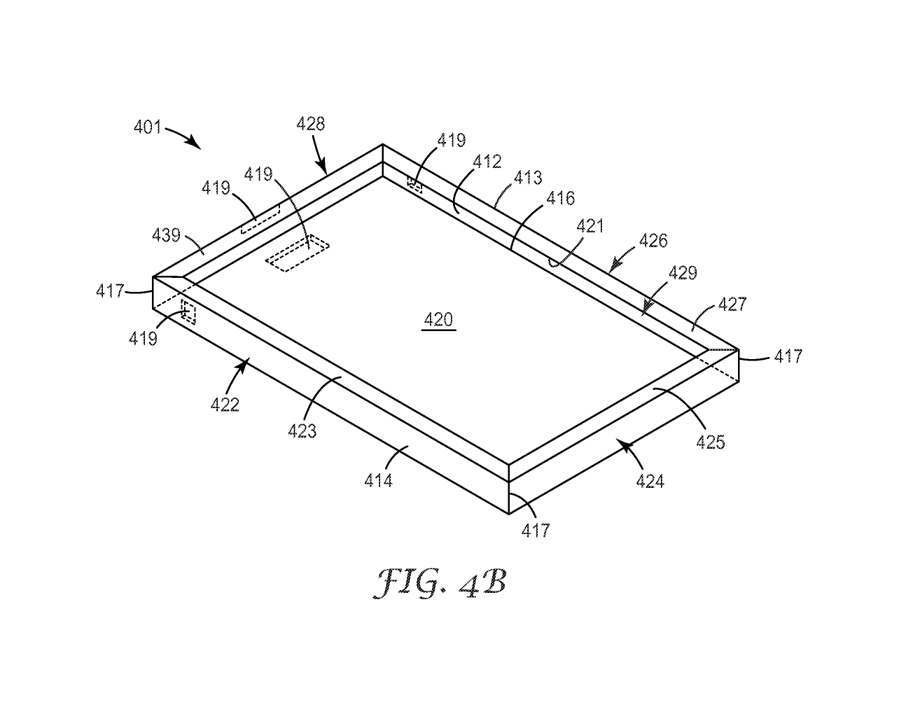

FIG. 2H shows a cross-sectional schematic view of a backlight module 207 including an LCD panel 260, according to one aspect of the disclosure. Each of the elements 201-264 shown in FIG. 2H correspond to like-numbered elements 201-264 shown in FIG. 2C, which have been described previously. Backlight module 207 includes a reflective tray 201 having sides 224, 228, bottom area 220, interior surface 212, exterior surface 214, bending line 216, a light source 230 having at least one light 232, and light guide 240 optically coupled to light source 230. A light management film stack 250 having at least one light management film is disposed within reflective tray 201. Reflective tray 201 includes a rim 225, 239, that extends over a portion of the top 229, as described elsewhere with reference to FIGS. 4A-4B. An LCD panel 260 having a top surface 262 and an opposing bottom surface 264 is positioned adjacent the light management film stack 250. The LCD panel 260 can be larger than the reflective tray 201, and the rim 225, 239 of reflective tray 201 can be positioned adjacent bottom surface 264 of LCD panel 260. In some cases, an adhesive layer (not shown) can attach the rim 225, 239 of the reflective tray 201 to the bottom surface 264 of LCD panel 260. In some cases, a topmost film (similar to that shown in FIG. 2G) of the light management film stack 250 can be disposed adjacent the rim 225, 239 and adhered to it, thereby forming a sealed reflective tray 201 which can be positioned adjacent the bottom surface 264 of the LCD panel 260.

FIG. 3 shows a perspective schematic view of a backlight module 300 including an LCD panel 360, according to one aspect of the disclosure. Each of the elements 301-362 shown in FIG. 3 correspond to like-numbered elements 201-262 shown in FIG. 2C, which have been described previously. For example, corner 317 in FIG. 3 corresponds to corner 217 in FIG. 2C, and so on. Backlight module 300 includes a reflective tray 301 having sides 322, 324, 326, 328, bottom area 320, exterior surface 214, corners 317, and perimeter 321. An LCD panel 360 having a top surface 262 is positioned within reflective tray 301 adjacent the perimeter 321. First electrical connection 334 communicates with a light source (not shown) interior to the reflective tray 301 and extends outside the reflective tray 301, as described elsewhere. Second electrical connection 365 communicates with the LCD panel 360 interior to the reflective tray 301 and extends outside the reflective tray 301.

FIG. 4A shows a perspective schematic view of a bendable template 400 that can be used to form a reflective tray according to methods of the disclosure. Bendable template 400 is made from a reflective sheet 410 that includes a first major surface 412, an opposing second major surface 414, and a perimeter 421. Exterior portions 418 are removed from the corners of the reflective sheet 410 to form edges 415, and optional openings 419 are cut through the thickness dimension of the reflective sheet. The exterior portions 418 and optional openings 419 can be removed using any suitable technique including, for example, knife cutting, die cutting, punching, laser cutting, and the like. A first bending line 416 that is generally parallel to and separated from the perimeter denotes where reflective sheet 410 can be bended to form a tray having sides and a bottom, as described elsewhere.

A second bending line 413 that is generally parallel to and separated from both the perimeter 421 and first bending line 416 denotes where reflective sheet 410 can be bended to form a tray having sides, a bottom, and a rim, as described elsewhere.

In one particular embodiment, the second bending line 413 and the first bending line 416 can both be disposed on the same major surface such as the first major surface 412, and the subsequent bends can form a “C” shape when viewed along the score lines, as shown in FIG. 4B. In this embodiment, the rim is disposed “within the tray” over the bottom, as described elsewhere. In some cases, the second bending line 413 and the first bending line 416 can be disposed on opposing major surfaces such as the first bending line 416 can be on the first major surface 412 and the second bending line 413 can be on the second major surface 414. In this case, the subsequent bends can form a “Z” shape when viewed along the score lines, and the rim is disposed “outside of the tray” (not shown in FIG. 4B). It is to be understood that the placement of each of the first and second bending lines 413, 416, can be on whichever major surface is necessary to form the desired tray shape, and in some cases, the rim can be inside the tray or outside the tray on any desired number of sides. It is also to be understood that the bending lines may not actually be visible on the template but merely understood to be the locations where bends will be formed.

FIG. 4B shows a perspective schematic view of a reflective tray 401 formed from the bendable template 400 of FIG. 4A, according to one aspect of the disclosure. Reflective tray 401 is formed by bending up each of the portions between the first bending line 416, the second bending line 413, and perimeter 421 so that each of the edges 415 meet to form a corner 417. Reflective tray 401 includes a bottom area 420, a first through fourth sides 422, 424, 426, and 428, an open top 429, a first through fourth rim 423, 425, 427, 239 extending over a portion of the open top surface 429 (i.e., “within the tray”), and interior surface 412 and exterior surface 414. It is to be understood from the discussion with reference to FIG. 4A, that depending on which major surface of the reflective sheet 410 the first and second bending lines 416, 413 are disposed, the first through fourth rim 423, 425, 427, 239 can extend either “within the tray” as shown in FIG. 4B, “outside of the tray” (not shown), or a combination of “within the tray” and “outside of the tray”. Optional openings 419 are positioned in any or all of the bottom area 420, sides 422, 424, 426, 428, and rims 423, 425, 427, 439, as desired, for attachment of components within the reflective tray 401 or for through-passage of electrical lines and the like, as described elsewhere. It is to be understood that reflective tray 401 can be substituted for any of the reflective trays 201 shown in FIGS. 2A-2H, and one of skill in the art would realize that any of the reflective trays 201 can also include one or more rims extending either “within the tray” or “outside the tray”.

In one particular embodiment, corners 417 may include an adhesive layer (not shown) or an adhesive tape (not shown) to bond the respective sides together. In some cases, corners 417 may be bonded together by other techniques including thermal bolding, ultrasonic welding, laser welding, or mechanical methods including slot/tab techniques and the like, as known to one of skill in the art.

A variety of layers can be applied to any desired portion of the interior surface 412 and/or the exterior surface 414, as desired. These layers are optional, and can include coatings, films, and sheets that are deposited, adhered, laminated, or otherwise affixed to the respective surface. In one particular embodiment, the layer applied to the exterior surface 414 can be, for example, a thermally conductive layer, an optically absorptive layer, a combination thereof, and the like. In some cases, a thermally conductive exterior layer having, for example, thermally conductive particles in a binder, or metallic films or sheets, can be useful for aiding extraction of heat from a light source (not shown) that is placed within the reflective tray 401, as described elsewhere. In one particular embodiment, the layer applied to the interior surface 412 can be a diffuse layer, an optically absorptive layer, or a combination thereof. In some cases, a diffuse layer can be preferably applied to the interior surface 412 of one or more of the sides 422, 424, 426, 428, one or more of the rims 423, 425, 427, 439, or the bottom 420, of the reflective tray 401.

Reflective trays such as those described above can be formed according to methods of the invention that involve bending edges of a reflective sheet by pressing a blade edge into the reflective sheet against a compliant pad. The compliant pad deforms and “flows” around the sharp edge forcing the reflective film to bend causing sufficient localized plastic strain to result in a permanent bend in the reflective sheet. Preferably the bends are 90 degrees so that the resulting reflective tray sides extend perpendicular to the reflective tray bottom.

As used herein, references to bends of “90 degrees” and planes that are “perpendicular” to another plane are to be understood as being modified in all instances by the term “about.” Accordingly, these parameters are approximations that can vary depending upon the desired properties sought to be obtained by those skilled in the art utilizing the teachings disclosed herein. For example, it is generally acceptable for the sides of the reflective trays described herein to be within ±5 degrees of perpendicular to the tray bottom. In some embodiments it is preferred that the sides of the reflective trays be within ±2 degrees of perpendicular to the tray bottom. Furthermore, a “90 degree” bend can comprise two or more bends (for example, two 45 degree bends, three 30 degree bends, etc.) that together result in a 90 degree total bend.

In order to achieve a 90 degree bend without damaging the reflective sheet, multiple parameters, for example, the sharpness of the blade tip, the rigidity of the compliant pad and the force applied to the blade, must be balanced.

Suitable compliant pads for use in the methods of the invention can be made of various materials and can comprise one or more layers or sheets of the same or varying materials. The compliant pad needs to be soft enough to deform around the blade edge, but it also needs to be rigid enough to cause the reflective film to deform. The compliance or rigidity of the compliant pad is dependent upon the overall thickness of the pad and its material(s). The overall compliance of the compliant pad can be determined by measuring Shore A or D durometer using ASTM D2240-00. As used herein, the “effective” Shore A or D durometer of the pad is the durometer measured according to ASTM D2240-00 of the entire pad. In other words, the compliant pad may comprise two or more layers with each layer having a different Shore A or D durometer, but the effective durometer of the compliant pad is the Shore A or D durometer measured on the entire pad with all of the layers stacked together. Suitable compliant pads typically have an effective Shore A durometer of 20 to 70, and preferably of 30 to 50. The pad can comprise, for example, rubbers, silicones, elastomers, plastics, and the like and combinations thereof.

The blade edge can have any useful tip geometry. For example, the tip can be rounded or flat, straight, angled or multifaceted. The tip should not be so sharp, that it cuts through the reflective sheet. What is or is not too sharp, however, will partially depend upon the rigidity of compliant pad being used. In one embodiment, the blade edge has a rounded tip with a radius of 0.5 μm to 2 μm. In another embodiment, the blade edge has a narrow flat tip that is 50 μm to 500 μm wide, and in some embodiments preferably 100 μm to 400 μm wide. A narrow flat tip makes two 45 degree bends that result in a 90 degree total bend. Other tip geometries can be utilized to make three or more bends that result in a 90 degree total bend. In some applications, such a “double bend” or “multiple bend” may be preferred because a 90 degree bend can be achieved with less deformation to the reflective sheet.

The blade edge is pressed into the reflective sheet with enough force to bend the sheet 90 degrees but without cutting the sheet. The appropriate amount of force will depend upon factors such as the sharpness of the blade tip, the length of the blade and the rigidity of the compliant pad; however, in general is has been found that a press force of 200 lbs to 400 lbs (890 N to 1800 N) is useful for forming 90 degree bends in polymeric dielectric multilayer reflectors. Any useful means such as, for example, a hydraulic press, a pneumatic press, linear servo actuators or the like, can be used to apply the force.

Optionally, heat can be used in the methods of the invention to facilitate deformation. When heat is utilized, the blade, the compliant pad and/or the reflective sheet can be heated.

The methods of the present invention are particularly useful when the reflective sheet is a dielectric multilayer reflector such as a polymeric dielectric multilayer reflector. Dielectric multilayer reflectors can sometimes delaminate when other methods are used for bending. Some dielectric multilayer reflectors comprise an opaque coating such as a black coating. The opaque coating can scratch off when traditional methods for bending metal are used. We have discovered that the opaque coating does not scratch off when the methods of the present invention are utilized. In addition, some dielectric multilayer reflectors comprise a liner on one or both sides of the reflective sheet. The methods of the invention can be used without removing the liner(s).

### EXAMPLES

Objects and advantages of this invention are further illustrated by the following examples, but the particular materials and amounts thereof recited in these examples, as well as other conditions and details, should not be construed to unduly limit this invention.

### Example 1

A bended film part was made according to the following procedure. Three layers of rubber 501, 502 and 503 were placed on an aluminum plate 504 of dimensions 5.75 in by 5.75 in by 0.078 in (14.6 cm by 14.6 cm by 0.2 cm). The first layer 501 immediately above the aluminum plate was a 60 Shore A durometer rubber sheet, 1/16 in (0.16 cm) thick. The next two layers of rubber 502 and 503 were both 30 Shore A durometer rubber sheets 1/16 in (0.16 cm) thick. (All rubber sheets were silicon rubber sheets obtained from McMaster-Carr, Elhurst IL.) The film to be bended was a specular reflector 505 with black coating on one side (available as ESR-B2 from 3M Company, St. Paul, Minn.). This film was placed on top of the rubber stack with the reflective (non-black) side facing away from the rubber. Then a die plate 506 with a knife (507 or 508) along each of its edges was placed with one of the knife blade edges (the edge of 507) on the film 505 aligned with the desired bend line. The other knife blade 508 rested on rubber with no film beneath it. The die plate 506 with knife blades was made by gluing two knife blades 507 and 508 to an aluminum block 509 of dimensions 4.7 in by 2.58 in by 0.24 in (11.9 cm by 6.6 cm by 0.61 cm). Scotch™ Super Glue Gel (available from 3M Company) was used as an adhesive and the knife blades were OLFA utility knife replacement blades (available as OLFA #180 from OLFA—North America, Rosemont Ill.). The knife blades were glued to the aluminum block so that the blunt edges of the blades were flush with one face of the aluminum block. This left about 0.14 in (0.36 cm) of the sharp end of the blades sticking out past the other face of the aluminum block.

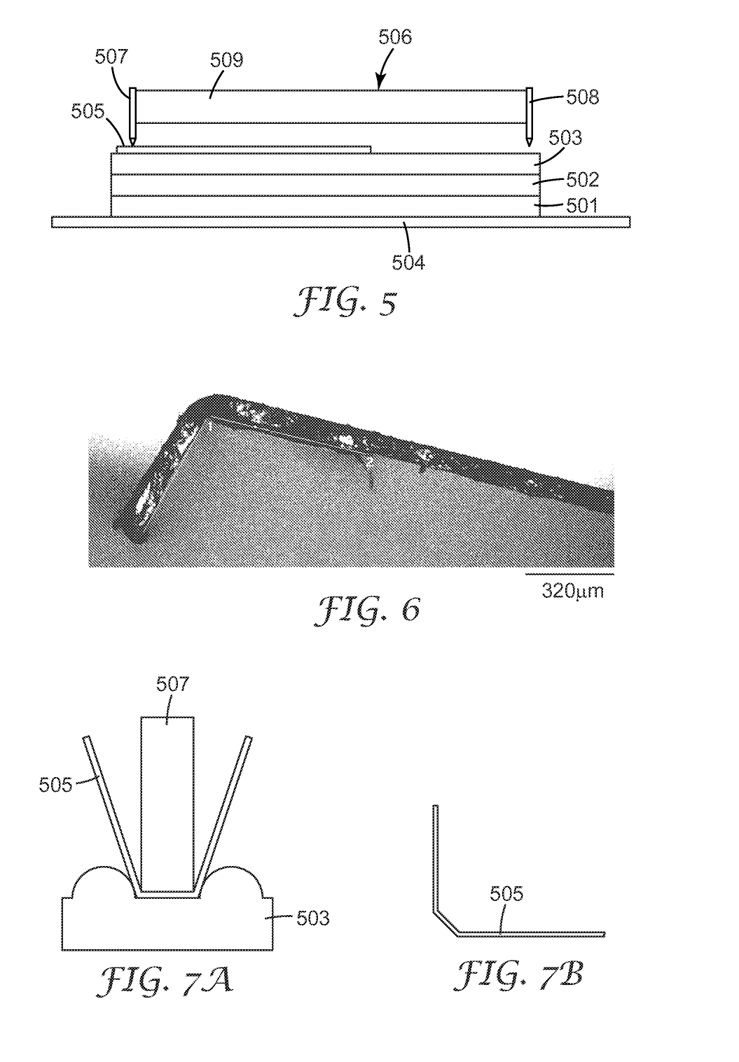

The stack as described (and shown in FIG. 5) was then placed between the platens of a Carter hydraulic press (Carver Model M from Carver, Inc., Wabash IN) (not shown). The hand lever of the hydraulic press was then pumped until the press exerted about 300 pounds (1330 N) of force on the assembly and thereby pressed the knife blade 507 into the film. The rubber layers 501, 502 and 503 under the film 505 deformed around the blade and caused permanent deformation in the film. When the 300 pound force was achieved the pressure was released and the stack was removed from the press. The film 505 then had an edge bent at about 90 degrees with respect to the remainder of the film. The resulting film 601, with bends made by this method, is shown in FIG. 6.

### Example 2

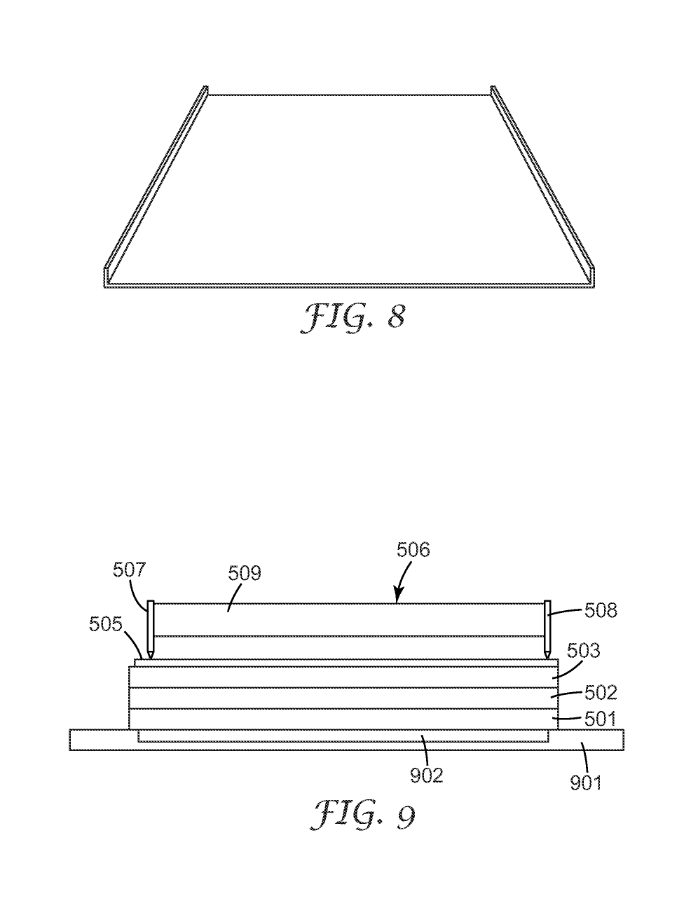

A bended film was made as in Example 1, except that the knife blade orientations were reversed so that the blades 507 and 508 were adhered to the aluminum block 509 with their flat edges exposed and facing the film 505, and that the film was positioned so that both blades were pressed against the film. The flat tip of the blade was 0.37 mm wide. One resulting bend is shown schematically in FIG. 7A and FIG. 7B. These indicate how the 90 degree bend arose from two 45 degree bends. FIG. 7A shows blade 507 with flat edge meeting and bending film 505 against rubber layer 503. FIG. 7B shows a schematic of bended film 505 made by bending with a flat-tipped blade. FIG. 8 shows a sample made by simultaneously bending two edges with two flat-tipped blades.

### Example 3

A bended film was made as in Example 1 except that the film was positioned so that both blades were pressed against the film. When force was applied to the film 505 by the press, the rubber 503 between the blades 507 and 508 deformed (bulged up). Since the film was pinned down by the sharp knife edges of 507 and 508 it was stretched excessively and subsequently torn. This did not occur in Example 2 where it was easier for the film 505 to slip with respect to the flat tip of the blades.

### Example 4

A bended film was made as in Example 1 except that the 60 Shore A durometer rubber sheet 501 was replaced by a 70 Shore A durometer rubber sheet. The blade was observed to cut the film 505 instead of forming a bend when the nominal load of 300 pounds was applied. When the applied force was lowered to about 200 pounds to avoid cutting through the film, the bend angle obtained was about 45 degrees.

### Example 5

A bended film was made as in Example 1 except that the force applied by the press was about 400 pounds (1779 N). The film 505 was cut through when this force was applied.

### Example 6

A bended film was made as in Example 1 except that the bottom aluminum plate 504 was replaced by a plate 901 with a recess 902 (FIG. 9). Both blades were placed against the film 505. The recess 902 in the bottom aluminum plate 901 provided room for the rubber layers 501, 502 and 503 to expand and prevented excessive stretching of the film 505 that caused failure in Example 3.

The complete disclosures of the publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A method of making a reflective tray comprising:
(a) providing a reflective tray template comprising a polymeric dielectric multilayer reflector on a compliant pad, the reflective tray template having a first major surface, an opposing major surface, and a reflective tray bottom area having corners;
(b) pressing a blade into the first major surface of the polymeric dielectric multilayer reflector along the perimeter of at least one side of the reflective tray bottom area to form a reflective tray side extending perpendicular to the reflective tray bottom area.

2. The method of claim 1 wherein portions of the polymeric dielectric multilayer reflector exterior to the reflective tray bottom area and adjacent the corners are removed.

3. The method of claim 1 or 2 wherein the compliant pad has an effective Shore A durometer of 20 to 70.

4. The method of claim 3 wherein the compliant pad has an effective Shore A durometer of 30 to 50.

5. The method of claim 1 wherein pressing a blade into the first major surface of the polymeric dielectric multilayer reflector comprises using a hydraulic press.

6. The method of claim 1 wherein the blade edge has a flat tip.

7. The method of claim 6 wherein the flat tip is 50 μm to 500 μm wide.

8. The method of claim 6 wherein the flat tip is 100 μm to 400 μm wide.

9. The method of claim 1 wherein the blade edge has a radius of 0.5 μm to 2 μm.

10. The method of claim 1 wherein the polymeric dielectric multilayer reflector compromises an opaque coating on at least one major surface.

11. The method of claim 1 wherein the polymeric dielectric multilayer reflector comprises a liner on at least one major surface.

12. The method of claim 1 further comprising applying heat to at least one of the blade edge, the compliant pad and the polymeric dielectric multilayer reflector.

13. The method of claim 1 wherein the reflective tray bottom area is rectangular.

14. The method of claim 13 further comprising pressing a blade edge into the first major surface of the polymeric dielectric multilayer reflector along the perimeter of each side of the reflective tray bottom area to form a reflective tray have four sides extending perpendicular to the reflective tray bottom area.

15. The method of claim 1 wherein two or more sides of the reflective tray bottom areas are formed simultaneously.

16. The method of claim 1 wherein the reflective tray template and compliant pad are provided on a plate having a recess.
